(19) United States
(12) Patent Application Publication
(10) Pub. No.: US 2008/0151813 A1
(43) Pub. Date: Jun. 26, 2008

(54) Method and apparatus for fast system initial acquisition in mobile WiMAX systems

(75) Inventors: Guanbin Xing, Issaquah, WA (US); Manyuan Shen, Sunnyvale, CA (US)

Correspondence Address: FULBRIGHT & JAWORSKI L.L.P, 2200 ROSS AVENUE, SUITE 2800, DALLAS, TX, 75201-2784, US

(73) Assignee: Adaptix, Inc., Seattle, WA (US)

(21) Appl. No.: 11/645,110

(22) Filed: Dec. 22, 2006

(51) Int. Cl. H04B 7/212

(52) U.S. Cl. 370/324

(57) ABSTRACT

A system and method of signal detection is provided. A received signal may be correlated with combinations of reference signals, each combination representing a subset of the reference signals, rather than being correlated with each reference signal individually. Once the timing offset has been found, the specific reference signal matching the received signal may be found with a one-dimensional (1D) search. A large 2-D search is thus reduced to a smaller 2-D search followed by a 1-D search. The system and method may be applied to downlink initial acquisition in mobile WiMAX systems.

### TECHNICAL FIELD

This invention relates to air interface communication systems synchronization between base stations and mobile devices and more particularly to initial acquisition and synchronization.

### BACKGROUND OF THE INVENTION

In wireless (air interface) communication systems, when a new user attempts to access a network, such as by powering on a subscriber unit, the subscriber unit needs to determine the frame/symbol timing of the downlink transmission from the network, along with the frequency offset and an identifying code (“cell ID”). Methods for determining this information include energy gap detection, auto-correlation, cyclic prefix detection, and cross-correlation.

The initial acquisition of WiMAX signals based in the IEEE 802.16e standard, however, pose challenges. Some of the reasons for the challenges include low operating signal-to-noise ratios (SNRs), lack of a repetition structure in the preamble, inconsistent repetition of the cyclic prefix, a large number of possible cell IDs, and potentially large frequency offsets. The low SNR affects the reliability of energy gap detection, the lack of a repetition structure in the preamble reduces the effectiveness of autocorrelation, inconsistencies in repetition reduce the effectiveness of cyclic prefix detection, and the large frequency offsets coupled with the number of cell IDs creates a significant computational burden for cross-correlation. The problem is compounded by the fact that at startup the subscriber unit is “blind” at power up (since it has little, if any, prior knowledge of the network, including timing and basestation codes). As a result the subscriber unit performs exhaustive searching, which is computationally expensive.

Time division duplexing (TDD) systems alternate between periods of transmission and reception. Energy gap detection attempts to ascertain the different periods by determining the level of energy in the appropriate frequency ranges. The boundaries of this gap then allow determination of timing information, which is used for acquisition. However, in low SNR environments, such as approximately 0 dB or lower, high noise or interference levels could prevent a detector from identifying a cessation in transmission by the subscriber unit. This is because the signal and interference levels are approximately the same when the SNR is close to 0 dB.

Autocorrelation schemes take advantage of identical segments in a transmission. That is, when a signal is correlated with a time-delayed version of itself, the identical segments, typically in a preamble, will produce a peak in the autocorrelation. This peak can then be used in the initial acquisition. If, however, the preamble does not have a repetition structure, the autocorrelation scheme may not provide the necessary peak. An alternative would be to leverage cyclic prefix timing detectors. A cyclic prefix is a common technique used in orthogonal frequency division multiplexing (OFDM) systems, which for each OFDM symbol is coded. This provides a form of a repetition structure, but it only occurs in part of a transmission frame and is not consistent in a TDD system.

Cross-correlation schemes are common techniques used for timing synchronization in which locally-stored versions of reference signals are correlated with the received signal in order to determine which one matches the basestation's transmitted cell ID. Each Basestation's cell ID is selected by the network planning from a set of predefined codes. However, WiMAX signals based in the IEEE 802.16e standard have a large code space consisting of 114 possible predefined codes. In a typical cross-correlation scheme, the received signal is correlated with all possible codes, along with various timing offsets. That is, a typical cross-correlation scheme attempts to solve:

$${max}_{m , k} [ {\vert {\sum }_{n = 1}^{L} r * ( n ) \cdot {c}_{k} ( n + m ) \vert}^{2} ]$$

where m is the timing offset, k is the reference code index, n is the sample index, L is the preamble length, r(n) is the received signal, and cₖ(n) is the k^{th} local reference.

This is a two-dimensional (2D) search problem, which attempts to determine both the identifying code and the timing offset simultaneously. The m and k which maximize the correlation value are solved for simultaneously. The computational requirement may become burdensome for systems that may have a large number of matched filters, such as 114, where each one requires testing with multiple time shifts.

### BRIEF SUMMARY OF THE INVENTION

A received signal may be correlated with combinations of reference signals, each combination representing a subset of the reference signals, rather than being correlated with each reference signal individually. This reduces the number of computations needed to determine the timing offset. Once the timing offset has been found, the specific reference signal matching the received signal may be found with a one-dimensional (1D) search. If one of the representations produced a clear enough correlation peak, only the reference signals in the subset corresponding to that representation need to be correlated with the received signal in order to determine the transmitted code. A large 2-D search is thus reduced to a smaller 2-D search followed by a 1-D search.

Embodiments of the invention use representations for subsets of reference signals, such as a summation of each reference signal in the subset, and cross-correlate a received signal with the representations to determine the timing offset and a candidate subset. The candidate subset corresponds to the representation which produces the highest correlation value, and is expected to contain the reference signal which matches the code in the received signal. After the timing offset and candidate subset have been found, embodiments of the invention then cross-correlate only those reference signals in the candidate subset with the received signal preamble in order to determine which of the predefined identifying codes is present.

Embodiments of the invention provide for a method of signal detection comprising: determining a timing offset of a received signal using representations of reference signals, wherein at least one of the reference signals is expected to correlate with at least a portion of the received signal, and wherein at least one of the representations is a representation of two or more of the reference signals; and determining which of the reference signals matches said received signal using the timing offset. The received signal may be a WiMAX signal, which comprises a preamble containing an identifying code from a set of predefined codes. The set of reference signals would then correspond to the set of predefined codes, and the representations may be created by summing or averaging the reference signals in each subset. The determination of the timing offset may comprise cross-correlating the received signal with the representations. This allows identification of a candidate subset using the highest value of the cross-correlation results. If desired, embodiments of the invention may reconfigure the subsets and create new representations.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates one embodiment of a method for initial acquisition of a network downlink transmission by a subscriber unit;

FIG. 2 illustrates one embodiment of a method for management and use of reference signal subsets;

FIG. 3 shows representative performance curves for differing subset sizes; and

FIG. 4 shows an air interface system in which the concepts of the invention may be practiced.

### DETAILED DESCRIPTION OF THE INVENTION

It is not necessary to resolve both the timing offset and identify the specific reference code simultaneously. Rather, it is computationally advantageous to break the search problem into two steps: First the timing offset is found using a smaller search space, and then the specific reference code is identified. For example, if a system has 100 possible codes and 100 possible timing offset increments, the 2-D search must solve 100×100=10,000 correlation values. However, if the codes are divided into 10 subsets of 10 codes each only 10×100=1,000 correlation values for the first step. Once the 10 candidate subset has been identified and the timing offset has been resolved, only the 10 reference codes in the candidate subset will need to be correlated with the received signal, bringing the total number of correlations to only 1,000+10=1,010 rather than 10,000. The above numbers were selected for illustrative purposes only.

Once the set I of reference codes are partitioned into J subsets, denoted Iⱼ, representations for the subsets are generated. One way to form a representation, denoted c′ⱼ(n), is to sum the codes as shown:

$${c}_{j}^{′} ( n ) = {\sum }_{k ∈ {I}_{j}} {c}_{k} ( n ) , I = {I}_{1} ⋃ {I}_{2} ⋃ … ⋃ {I}_{J}$$

Cross-correlation is then done using the representations, rather than all of the individual codes:

$${max}_{m , j} [ {\vert {\sum }_{n = 1}^{L} r * ( n ) \cdot {c}_{j}^{′} ( n + m ) \vert}^{2} ]$$

where the m and j which maximize the correlation value are solved for simultaneously. While this remains a 2-D search problem, it may be considerably smaller. At this point, with m known, (denoted as \tilde{m}), the correlations need only be maximized for the k's within the candidate Iⱼ as shown:

$${max}_{k ∈ {I}_{j}} [ {\vert {\sum }_{n = 1}^{L} r * ( n ) \cdot {c}_{k} ( n + \tilde{m} ) \vert}^{2} ]$$

This is a 1D search problem, since the timing offset is fixed. Even if there is ambiguity regarding which Iⱼ contains the matching reference signal, reference signals in multiple subsets, possibly even all the reference signals may be tested in a 1D problem. This would still provide computational savings over a single, large 2D search. Using the notional numbers given above, the 100 reference codes tested in a 1D search would bring the total number of correlations to 1,000+100=1,100, which is still fewer than 10,000. Such ambiguity is not normally expected to be present, however it is considered acceptable where it allows for broader coverage.

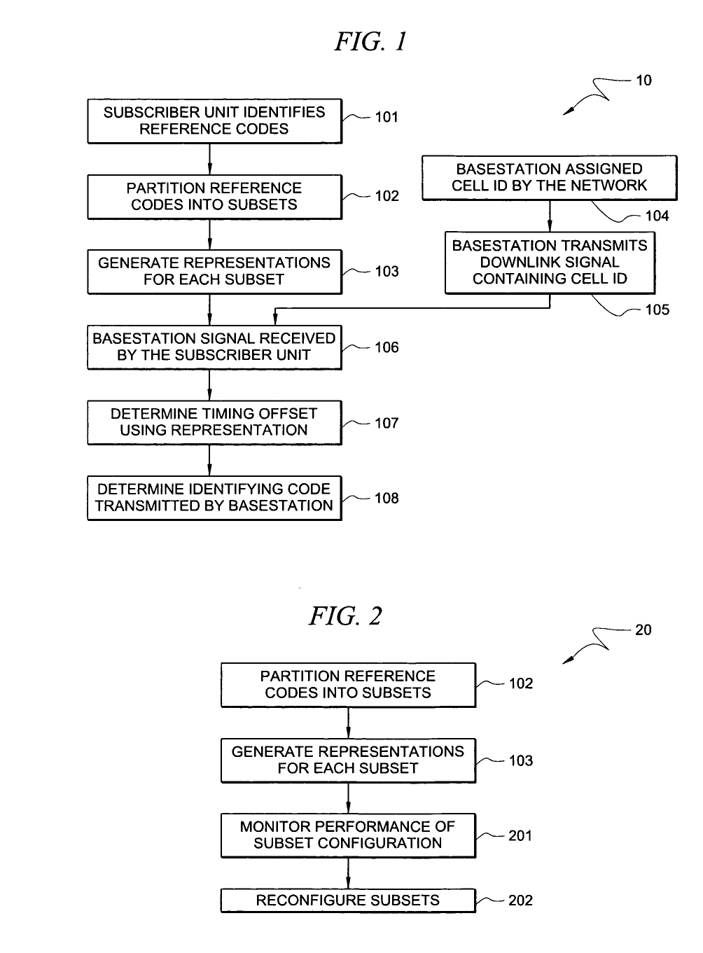

FIG. 1 shows method 10 for initial acquisition of a basestation downlink signal by a subscriber unit in accordance with an embodiment of the invention. Usually, each basestation in the network is assigned an identifying code (A.K.A. “Cell ID” through cell planning. The basestation transmits this code in every downlink signal. A set of predetermined reference codes are identified by the subscriber unit in box 101, and are partitioned into subsets in box 102. For each subset, a representation is generated in box 103. When a subscriber unit attempts to acquire synchronization to the network, it searches through all possible representations within box 103 and finds the best match to the identifying code transmitted by the basestation.

The basestation signal is received by the subscriber unit 44 in box 106, and is correlated with the representations in box 107 to determine the timing offset. With this information, and possibly a candidate subset also selected, the subscriber is able to determine the specific code transmitted by the basestation in box 108. At this point, initial acquisition and synchronization have been largely completed. It should be noted that, even if two or more subsets produce similar correlation results, such that there is ambiguity regarding which subset contains the matching reference code, the entire set of reference codes may be searched as a 1D problem. Thus, while identifying a candidate subgroup may speed computations, it is not necessary to identify a candidate subset in order to obtain significant computation savings.

FIG. 2 shows method 20 for management and use of reference signal subsets. The processes of boxes 102 and 103 are performed as previously described. In box 201, however, the performance of the subset configuration is monitored. Various performance metrics may be used, such as probability of detection, memory usage and computation time. If desired, the subsets may be reconfigured in box 202 by changing the sizes or by grouping the reference signals into the subsets with different criteria. The new subsets will then require new representations, which is performed by returning to box 103. It may be possible to optimize the subsets by iterating through method 20. Possibly, a changing operational environment may drive the requirement for reconfiguring the subsets.

Generally, the larger the subsets the better the computational savings may be. However, this comes at a cost. The more reference codes there are in each subset that must be represented simultaneously, the lower the probability of detection will be when attempting to solve for the timing offset. Thus, there is a trade-off between speed and accuracy. Criteria for selecting the operational point may include a required detection probability, SNR and computational burdens.

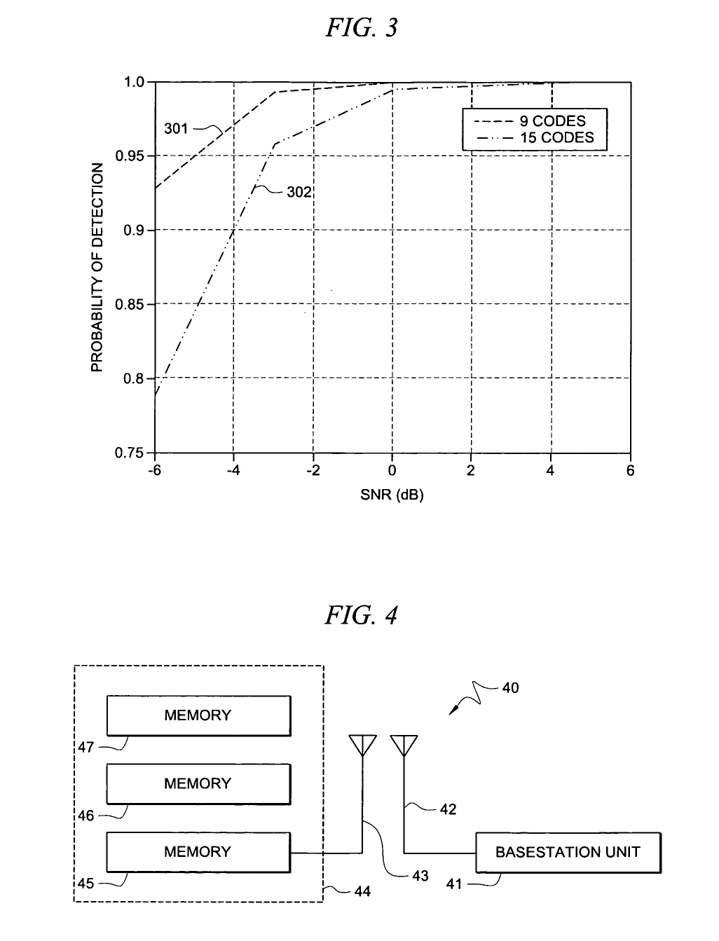

FIG. 3 shows plot 30 of representative performance curves 301 and 302 for differing subset sizes. As shown, curve 301 represents probability of detection versus SNR for subsets of size 9 with a set of 114 total reference codes. Curve 302 represents the performance for subsets of size 15. As can be expected, probability of detection drops for a given SNR when the subset size increases.

FIG. 4 shows air interface system 40 comprising basestation unit 41 and subscriber unit 44. Basestation 41 transmits a signal using antenna 42, which is then picked up by antenna 43 and routed to receiver 45 in the subscriber unit 44. Processor 46 communicates with memory 47 in order to store and retrieve the reference codes and their representations. Memory 47 may also contain software comprising instructions executable by processor 46 for implementing at least part of an embodiment of the invention. Memory 47 may comprise a computer readable medium which holds the instructions.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of signal detection comprising:
determining a timing offset of a received signal using representations of reference signals, wherein at least one of said reference signals is expected to correlate with at least a portion of said received signal, and wherein at least one of said representations is a representation of two or more of said reference signals; and
determining which of said reference signals matches said received signal using said timing offset.

2. The method of claim 1 wherein said received signal comprises a Worldwide Interoperability for Microwave Access (WiMAX) signal.

3. The method of claim 1 wherein said received signal comprises:
a preamble.

4. The method of claim 3 wherein said preamble comprises:
an identifying code belonging to a set of predefined codes.

5. The method of claim 4 wherein said set of predefined codes contains 114 codes.

6. The method of claim 4 wherein said reference signals correspond to said predefined codes.

7. The method of claim 1 further comprising:
determining said representations:

8. The method of claim 7 wherein said determining said representations comprises:
summing said reference signals for at least one of said subsets of reference signals.

9. The method of claim 7 wherein said determining said representations comprises:
averaging said reference signals for at least one of said subsets of reference signals.

10. The method of claim 1 wherein said determining a timing offset comprises:
correlating said received signal with said representations.

11. The method of claim 1 further comprising:
identifying a candidate subset of reference signals, wherein said candidate subset corresponds to a representation having a highest value of said correlations.

12. The method of claim 11 wherein said determining which of said reference signals matches said received signal comprises:
correlating said received signal with reference signals in said candidate subset.

13. The method of claim 1 further comprising:
reconfiguring said subsets.

14. A computer program, embodied on a computer-readable medium, that when executed by a processor performs signal detection, said computer program comprising:
code for determining a timing offset of a received signal using representations of reference signals, wherein at least one of said reference signals is expected to correlate with at least a portion of said received signal, and wherein at least one of said representations is a representation of two or more of said reference signals; and
code for determining which of said reference signals matches said received signal using said timing offset.

15. The computer program of claim 14 wherein said received signal comprises:
a preamble.

16. The computer program of claim 15 wherein said preamble comprises:
an identifying code belonging to a set of predefined codes.

17. The computer program of claim 16 wherein said reference signals correspond to said predefined codes.

18. The computer program of claim 14 wherein said determining representations comprises:
summing said reference signals for at least one of said subsets of reference signals.

19. The computer program of claim 14 wherein said determining a timing offset comprises:
correlating said received signal with said representations.

20. The computer program of claim 14 further comprising:
code for identifying a candidate subset of reference signals, wherein said candidate subset corresponds to a representation having a highest value of said correlations.

21. The computer program of claim 14 wherein said determining which of said reference signals matches said received signal comprises:
correlating said received signal with reference signals in said candidate subset.

22. The computer program of claim 14 further comprising:
code for reconfiguring said subsets.

23. The computer program of claim 22 further comprising:
code for optimizing said subsets.

24. The computer program of claim 23 wherein said optimization attempts to minimize computational burden for a selected probability of detection.

25. A system for detecting signals comprising:
means for receiving a signal;
means for determining a timing offset of said received signal using representations of reference signals, wherein at least one of said reference signals is expected to correlate with at least a portion of said received signal, and wherein at least one of said representations is a representation of two or more of said reference signals; and
means for determining which of said reference signals matches said received signal using said timing offset.

26. The system of claim 25 wherein said received signal comprises:
a preamble comprising an identifying code belonging to a set of predefined codes.

27. The system of claim 25 wherein said reference signals correspond to said predefined codes.

28. The system of claim 25 further comprising:
means for determining said representations:

29. The system of claim 25 wherein said determining said representations comprises:
summing said reference signals for at least one of said subsets of reference signals.

30. The system of claim 25 wherein said determining a timing offset comprises:
correlating said received signal with said representations.

31. The system of claim 25 further comprising:
means for identifying a candidate subset of reference signals, wherein said candidate subset corresponds to a representation having a highest value of said correlations.

32. The system of claim 25 wherein said determining which of said reference signals matches said received signal comprises:
correlating said received signal with reference signals in said candidate subset.
